(19) United States
(12) Patent Application Publication
(10) Pub. No.: US 2004/0090930 A1
(43) Pub. Date: May 13, 2004

(54) Authentication method and system for public wireless local area network system

(76) Inventors: Hyun-Woo Lee, Daejeon-City (KR); Chong-Ho Yoon, Seoul (KR); Dong-Hyun Lee, Kyungki-do (KR); Won Ryu, Daejeon-City (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/365,166

(22) Filed: Feb. 12, 2003

(30) Foreign Application Priority Data
Nov. 13, 2002 (KR) KR2002-70451

(51) Int. Cl. H04Q 7/00

(52) U.S. Cl. 370/328

(57) ABSTRACT

An authentication method and system for a public wireless local area network (WLAN) service system are provided. An authentication method for a public WLAN service system, which includes a WLAN user terminal, an access point (AP) for relaying communications to and from the user terminal, and an authentication server for processing authentication in response to a request for authentication from the user terminal, includes the steps of the user terminal asking the AP for access to the public WLAN; the AP searching for authentication information stored in the AP; if the authentication information is found, the AP performing an authentication process; and if the authentication information is not found, the AP asking the authentication server for authentication, and the authentication server performing the authentication process.

### BACKGROUND OF THE INVENTION

This application claims the priority of Korean Patent Application No. 2002-XXXX, filed on (month) (day), 2002, in the Korean Intellectual Property Office, the disclosure of which is incorporated herein in its entirety by reference.

1. Field of the Invention

The present invention generally relates to the field of wireless local area networks (WLANs), and more particularly, to an authentication method and system for a public WLAN service system, in which authentication of an authorized user can be performed within an access point with reference to a cache table thereof, so that it is not necessarily to perform an authentication process through a separate authentication server as in a conventional high-speed wireless Internet service system based on WLAN technologies.

2. Description of the Related Art

Generally, a wireless local area network (WLAN) is a telecommunications network that allows data communications between computers, or between computers and other communication systems using radio frequency (RF) or optical signals, not through wires or other physical communication lines. The WLAN has been fairly recently developed owing to rapid developments of Internet services and wireless telecommunication technologies. Because of conveniences for networking and maintenance, the WLAN is increasingly used particularly in the areas where networking with wires or other physical communication lines is not feasible, such as building-to-building networking, networking in large offices or logistics centers, etc.

Meanwhile, telecommunication service providers have recently introduced a high-speed wireless Internet service by adapting WLAN technologies that have mainly been used for indoor private networking to outdoor public networking, wherein the Internet services can be accessed in so-called hot spot areas by authorized users who have registered their own identification (ID) codes and passwords through a predetermined registration process. Here, users can gain access after an authentication process.

In a conventional public WLAN service system, an authentication process that is carried out when a user tries to access the network includes an authentication confirmation process that is repeatedly carried out through an authentication server whenever the user tries to access the network. According to the IEEE 802.1x standard, a user can use a physical port of an access point (AP) only after the user obtains authorization to use the physical port of the AP from the authentication server.

Since the authentication process must be performed on the authentication server as described above, access time is occasionally delayed, and consequently, much heavier traffic than actual user data traffic is caused in a backbone network. Further, an authentication server is required even for small-scale WLAN networking, and the need for a separate authentication server greatly increases the overall cost.

### SUMMARY OF THE INVENTION

The present invention provides an authentication method and system for a public WLAN service system, in which an authentication process can be performed not only via an authentication server but also with reference to a cache table within an access point to allow access to the public WLAN without having to use the authentication server.

According to the present invention, an authentication method for a public wireless local area network (LAN) service system, which includes a WLAN user terminal and an access point (AP) for relaying WLAN communications to and from the user terminal, includes the steps of the user terminal asking the AP for access to a physical port; and the AP performing an authentication process with reference to authentication information stored in the AP.

According to the present invention, an authentication method for a public WLAN service system, which includes a WLAN user terminal, an AP for relaying communications to and from the user terminal, and an authentication server for performing an authentication process in response to a request for authentication from the user terminal, includes the steps of (a) the user terminal asking the AP for access to the public WLAN; (b) the AP searching for authentication information stored in the AP; (c) if the authentication information is found in step (b), the AP performing an authentication process; and (d) if the authentication information is not found in the AP in step (b), the AP asking the authentication server for authentication, and the authentication server performing the authentication process.

In the authentication method according to the present invention, it is preferable that the search for authentication information stored in the AP in step (b) includes searching a cache table in which at least a user identification (ID) code and a user password are stored.

In the authentication method according to the present invention, it is preferable that step (a) includes the user terminal asking the AP for access to a physical port; and the AP asking the user terminal for a user ID code, and the user terminal transmitting its own user ID code to the AP, and if the AP is in an initialized mode or there is no authentication information in the cache table, step (a) additionally includes registering authentication information in the cache table of the AP, wherein if the user ID code transmitted from the user terminal to the AP is not in the cache table, the registering includes the AP temporarily storing the user ID code in the cache table; the AP asking the authentication server for a user password corresponding to the user ID code; if the user password is in the authentication server, the authentication server informing the user terminal via the AP that the authentication is successful and transmitting the user password to the AP, and the AP storing the user password in a password storing shell of the user ID code temporarily stored in the cache table; and if the user password is not in the authentication server, the authentication server informing the user terminal via the AP that the authentication has failed, and registering a new password in the password storing shell of the user ID code temporarily stored in the cache table.

In the authentication method according to the present invention, it is preferable that step (a) includes the user terminal asking the AP for access to a physical port; and the AP asking the user terminal for a user ID code and, as a response, the user terminal transmitting its own user ID code to the AP, and if the user ID code transmitted from the user terminal is in the cache table of the AP, step (c) includes the AP asking the user terminal for a user password, and allowing or refusing an access to the public WLAN according to the results of checking whether the user password transmitted from the user terminal is identical to the password stored in the cache table or not.

In the authentication method according to the present invention, it is preferable that the authentication method additionally includes verifying if the authentication by the AP is correct, after allowing the access to the public WLAN, by comparing the user ID code and the user password for which the access is allowed upon the asking from the AP with a user ID code and a user password stored in the authentication server.

In the authentication method according to the present invention, it is preferable that the authentication method additionally includes the step of the authentication server periodically checking if authentication information in the authentication server and the AP is identical with each other by periodically comparing the user ID code and the user password in the cache table with the user ID code and the user password stored in the authentication server.

In the authentication method according to the present invention, it is preferable that the allowing or refusing the access includes the AP transmitting a user ID code for authentication to the authentication server if the access is refused because the user password is different while the user ID code is identical, and if a password is asked for from the authentication server, the AP transmitting the user password received from the user terminal to the authentication server after adding a password requesting attribute of a type predetermined with the authentication server; the authentication server transmitting an authentication success or authentication failure message to the user terminal after adding a password responding attribute according to the result of authentication of the user password of the user terminal; the AP transmitting the authentication success message to the user terminal if the authentication success message is received by the AP from the authentication server, and updating corresponding information in the cache table; and disconnecting the access if the authentication failure message is received by the AP from the authentication server, and updating the cache table with a new password received from the authentication server.

The authentication method according to the present invention can be implemented on a recording medium that can be read from by a computer with a code that is readable by the computer.

An authentication system for a public WLAN service system includes a user terminal for accessing to the public LAN; an access point (AP) including a cache table for storing a user ID code and a user password, which checks the user ID code and the user password with reference to the cache table upon request from the user terminal for an access to the WLAN, and allows the access to the WLAN if the user ID code and the user password are confirmed, or transmits the user ID code and the user password to an authentication server if the user ID code and the user password are not confirmed; and an authentication server that receives the user ID code and the user password from the AP and performs an authentication process whether to allow the access to the WLAN.

### BRIEF DESCRIPTION OF THE DRAWINGS

The above object and advantages of the present invention will become more apparent by describing preferred embodiments thereof with reference to the attached drawings in which:

FIG. 1 shows an example of a public WLAN service system to which the present invention is applied;

FIG. 2 shows a user information registration procedure if an AP is in an initialized mode or there is no user information in a cache table;

FIG. 3 shows an authentication procedure directly at an AP without communicating with an authentication server if there is user information in a cache table of the AP;

FIG. 4 shows a procedure performed at an AP if a user password is different while a user ID code is identical during authentication process; and

FIG. 5 shows a scheme of a cache table used in an AP and a format of password requesting and responding RADIUS attribute data packet to be added for exchanges of an encrypted user password with an authentication server.

### DETAILED DESCRIPTION OF THE INVENTION

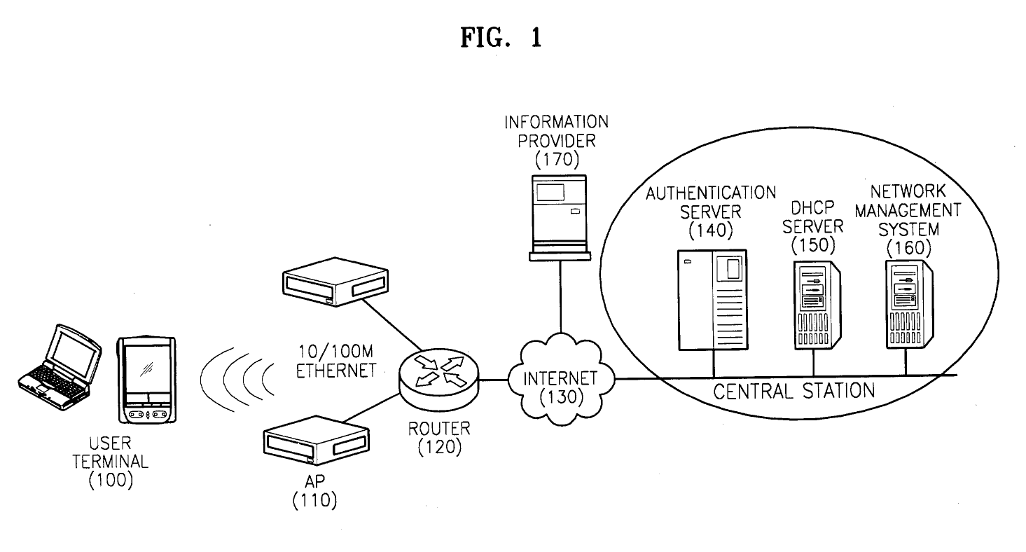

Referring to FIG. 1, there is shown an example of a construction of a public WLAN service system to which the present invention is applied. In order to have a wireless Internet service based on WLAN technologies, a user equips a WLAN card in a user terminal 100. Further, in order to access to a server of an information provider 170, the user should obtain an allowance for an access from an authentication server 140 that is operated by a telecommunications service provider through an access point (AP) 110 connected to a public Internet network 130. For this purpose, a public WLAN service network includes a plurality of access points 110 located in the areas where lots of users can gather, and a router 120 based on a exclusive line through which the access points are connected to the Internet 130. Further, the telecommunications service provider separately operates a dynamic host configuration protocol (DHCP) server 150 for assigning IP addresses to public WLAN user terminals, and a network management system 160.

An authentication system for a public WLAN service system according to the present invention includes at least one user terminal 100, at least one AP 110, and an authentication server 140 among the elements shown in FIG. 1. However, in case of a small-scale network, the authentication system can be operated without the authentication server 140 in such a way that an administrator inputs an identification (ID) code and a password of a user in a cache table.

The user terminal 100 includes any kind of terminals that can have Internet services through a WLAN. The AP 110 incorporates IEEE 802.1x function, and has a cache table for storing at least a user ID code and a user password. The AP 110 functions to confirm the user ID code and the user password with reference to the cache table in response to a request for accessing the WLAN from the user terminal 100, and to allow the access the WLAN if the user ID code and the user password are confirmed or transmits the user ID code and the password to the authentication server 140 if the user ID code and the user password are not confirmed. The authentication server 140 receives the user ID code and the user password from the AP 110 and authenticates whether to allow access to the WLAN.

For reference, the IEEE 802.1x and its operations will be explained below. The IEEE 802.1x is a standard regulating a cross authentication method of a wireless subscriber and a method for dynamically distributing master session keys for the securities during wireless access terms. The IEEE 802.1x provides an access control standard for allowing an access the WLAN only to an authorized subscriber by performing authentication at upper grades of MAC. Further, the IEEE 802.1x functions to distribute the master session keys dynamically produced by the subscriber and the authentication server during the authentication, from the authentication server to the AP. The distributed keys are utilized as basic keys for providing data privacies during wireless access terms in a unit of a packet later time. Therefore, the IEEE 802.1x has a dualized structure with an authentication subject (authentication server) and an access control subject (AP).

The IEEE 802.1x utilizes an extended authentication protocol (EAP) as a standard protocol for transmitting subscriber authentication data. Operations of the IEEE 802.1x protocol are relatively simple. If a user tries to access, an EAP-start message is transmitted to an AP. In response to the EAP-start message, the AP asks the user terminal for subscriber identification (ID) information needed for the subscriber authentication. In order to support global loaming of the user and billing, the subscriber ID should follow a network access ID (NAI) format like an email address format. The NAI format is necessarily followed in order to know a location of a home authentication server of the subscriber and to make possible distributed authentication. The user ID information received from the user is transmitted to the authentication server, and if the AP ultimately receives an authentication success or failure message from the authentication server, the authentication process is ended. Master session keys produced during the authentication are included in the authentication success or failure message transmitted to the AP. Then the AP performs key exchanges with the terminal to synchronize key-in timing. Thereafter, by sending an EAP-success message encrypted with the synchronized key, the AP informs the terminal that the access to the WLAN using the IEEE 802.1x is allowed. Thereafter, the terminal and the AP are guaranteed with privacies during wireless data terms using the dynamically distributed keys.

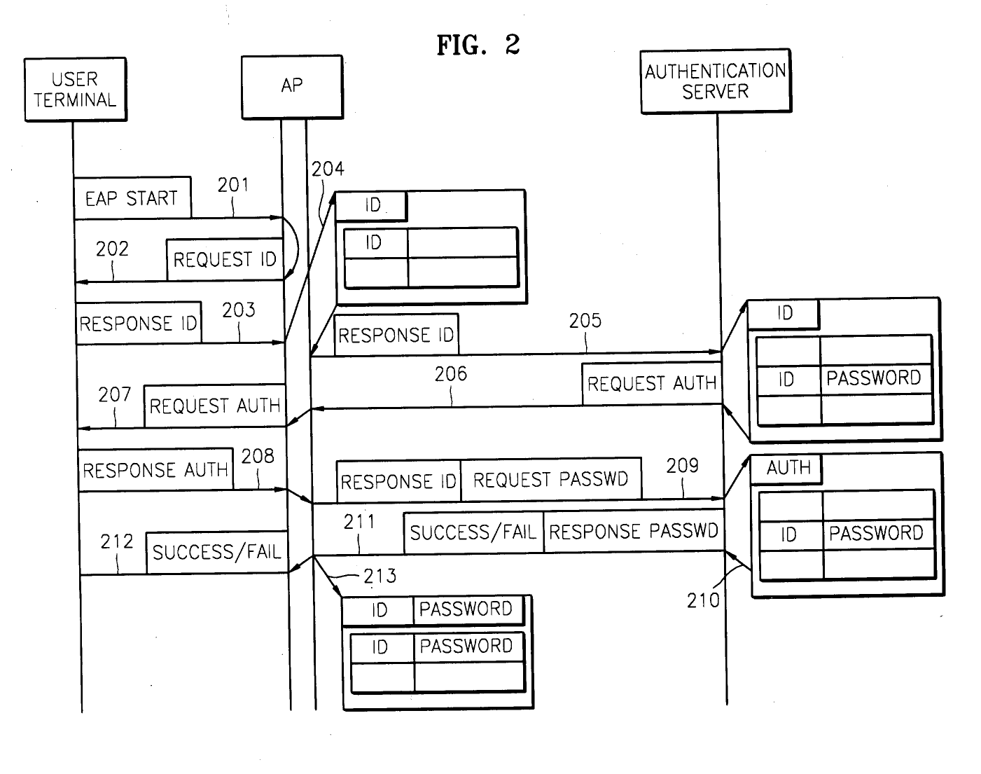

Referring to FIG. 2, there is shown a user information registration procedure in the event that an AP is in an initialized mode or there is no user information in a cache table. As an operation between a user terminal and an AP, the user terminal sends an EAP_START message to the AP incorporating IEEE 8012.1x function to ask for an access to public WLAN (STEP 201). As a response, the AP sends a REQUEST_ID message to the user terminal (STEP 202), and the user terminal answers with a user identification (ID) code as a RESPONSE_ID message to the AP (STEP 203). After receiving the RESPONSE_IS message from the user terminal, the AP checks if there is information on the user ID in a cache table, and if the user ID is not in the cache table, temporarily stores the user ID in the cache table (STEP 204). Thereafter, the AP transmits the RESPONSE_ID message to an authentication server (STEP 205), and the authentication server transmits a REQUEST_AUTH message to the AP for verifying a user password (STEP 206). The AP transmits the REQUEST_AUTH message to the user terminal (STEP 207). After receiving a RESPONSE_AUTH message from the user terminal (STEP 208), the AP adds a password request attribute of a type predetermined with the authentication server to the RESPONSE_AUTH message, and transmits the resultant message to the authentication server (STEP 209). According to the result of authentication for the user password of the user terminal, the authentication server adds a password response attribute that is encrypted in key values predetermined with the AP to an EAP_SUCCESS or EAP_FAIL message (STEP 210), and transmits the resultant message to the AP (STEP 211). If the EAP_SUCCESS message, a message to allow an access to the public WLAN, is transmitted to the user, the AP transmits an authentication success message, the EAP_SUCCESS message, to the user terminal (STEP 212), and searches out a corresponding ID and stores its password in the cache table (STEP 213). On the other hand, if the EAP_FAIL message is received, the AP transmits the EAP_FAIL message to the user terminal (STEP 212), and registers a new password to the ID stored in the cache table (STEP 213). Thereafter, if the user of the public WLAN again tries to access to the AP, the authentication is immediately provided without intercommunications with the authentication server because there is user information in the cache table.

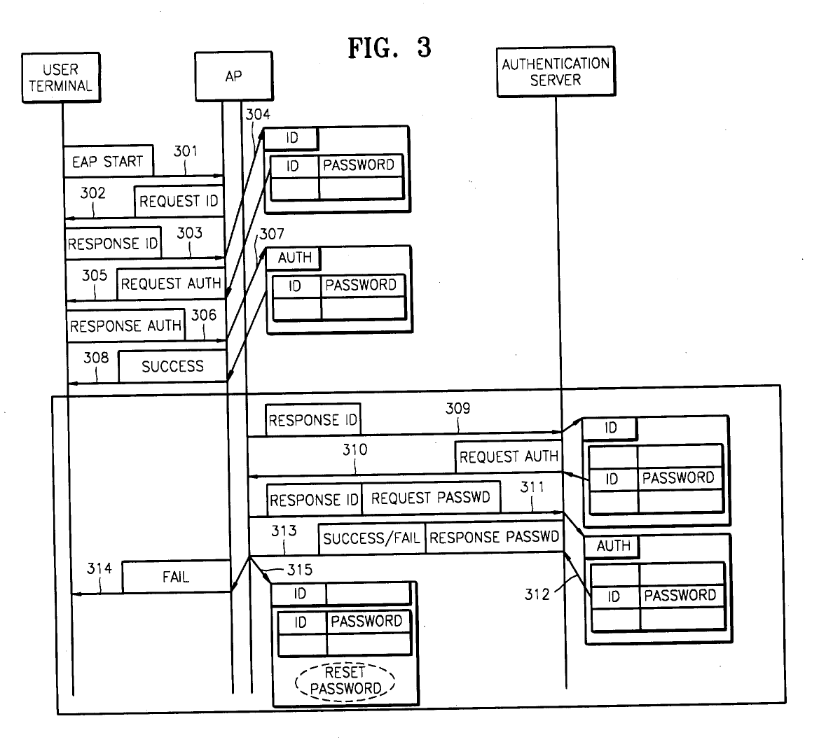

Referring to FIG. 3, there is shown an authentication procedure directly at an AP without communicating with an authentication server if there is user information in a cache table of the AP. In this procedure, the user terminal also asks the AP incorporating the IEEE 802.1x function for an access by sending an EAP_START message, as an operation between the user terminal and the AP (STEP 301), and the AP transmits a REQUEST_ID message to the user terminal as a response (STEP 302). The user terminal transmits a RESPONSE_ID message with its own ID to the AP (STEP 303). If the received user ID is in the cache table within the AP (STEP 304), the AP transmits a REQUEST_AUTH message to the user terminal (STEP 305). The user terminal received the REQUEST_AUTH message answers to the AP by transmitting a RESPONSE_AUTH message (STEP 306). After correspondence of the password is checked (STEP 307), an access to the public WLAN is allowed (STEP 308). Through the above procedure, the AP can perform the authentication process using the cache table within the AP, not necessarily intercommunicating with the authentication server.

The procedures enclosed by a rectangle in FIG. 3 are optional procedures for asking the authentication server if the authentication has been correctly performed after the AP transmits a message for allowing to use the AP using the cache table, or periodically rechecking the user information stored in the cache table. After the ID registered in the cache table together with the RESPONSE_ID message is transmitted to the authentication server (STEP 309), if the AP receives a REQUEST_AUTH message from the authentication server (STEP 310), the AP searches out the user ID and the user password in the cache table, and transmits a RESPONSE_AUTH message to the authentication server (STEP 311). If the authentication has been correctly performed (STEP 312), an EAP_SUCCESS message will be transmitted from the authentication server (STEP 313). If an EAP_FAIL message is received, a FAIL message is transmitted to the user terminal (STEP 314), and the password for the ID stored in the cache table is updated (STEP 315).

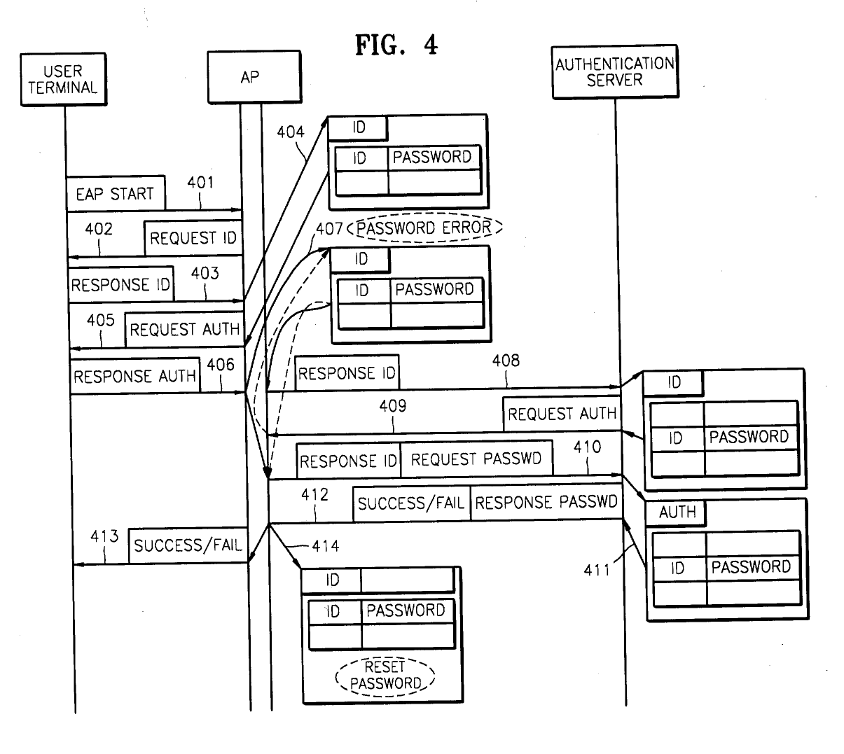

Referring to FIG. 4, there is shown a procedure performed at an AP if a user password is different while a user ID is identical during authentication process. If the password is different while the ID is identical during the authentication process at the AP, a user access fail occurs. Accordingly, it is required for the authentication server to confirm the authentication information. The authentication confirmation procedure is as follows. During the operation between the user terminal and the AP, the user terminal asks the AP incorporating the IEEE 802.1x function for an access to a public WLAN by sending an EAP_START message (STEP 401). As a response, the AP transmits a REQUEST_ID message to the user terminal (STEP 402), and the user terminal transmits its own ID together with a RESPONSE_ID message to the AP (STEP 403). If the ID information is searched out in the cache table (STEP 404), the AP transmits a REQUEST_AUTH message to the user terminal (STEP 405). The user terminal received the REQUEST_AUTH message responses with a RESPONSE_AUTH message (STEP 406), and the AP checks the correspondency of the password with reference to the cache table and decides whether to authenticate or not (STEP 407).

If the password is not in corresponding, the AP transmits the ID together with a RESPONSE_ID to the authentication server for requesting authentication (STEP 408), and if a RESPONSE_AUTH message is received from the authentication server (STEP 409), the AP adds a password requesting attribute of a type predetermined with the authentication server to the RESPONSE_AUTH message received from the user terminal in STEP 406, and transmits the resultant message to the authentication server (STEP 410). According to the result of authentication for the password of the user terminal, the authentication server adds a password response attribute encrypted in key values predetermined with the AP to an EAP_SUCCESS or EAP_FAIL message to be transmitted to the AP (STEP 411), and transmit the resultant message to the AP (STEP 412). The EAP_SUCCESS message received from the authentication server is transmitted to the user terminal (STEP 413), and the corresponding information in the cache table is updated (STEP 414). If the EAP_FAIL message is received, the access is disconnected (STEP 413), and the cache table is updated with a new password from the authentication server (STEP 414).

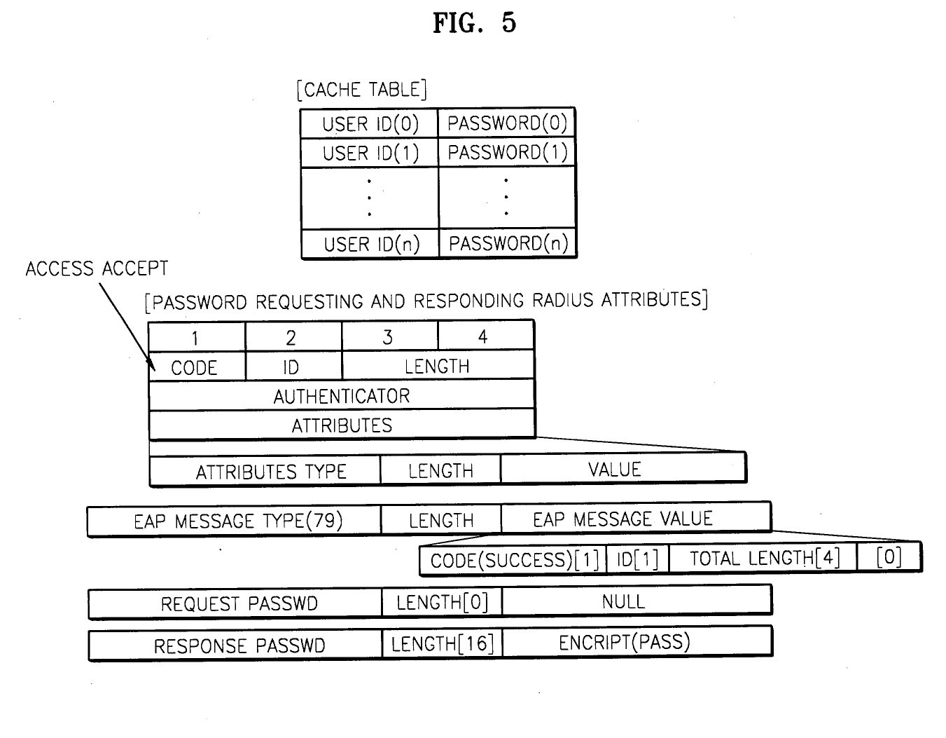

Referring to FIG. 5, there is shown a scheme of cache table used in an AP and a format of password requesting and responding RADIUS (Remote Authentication Dial In User Service) attribute data packet to be added for exchanges of an encrypted user password with an authentication server.

The cache table is simply formed with a list of user ID and password. When an AP receives a RESPONSE_ID message, the authentication is initiated. After checking if there is the received user ID is in the cache table, the AP starts the authentication if the user ID is in the cache table. If the user ID is not in the cache table, the authentication server starts the authentication. By using the cache table in the AP, it is possible for the AP to provide the user with the authentication whether to allow an access to the public WLAN. In addition, the AP requests for sending a user password corresponding to the user ID, the authentication server responds by sending the password for the user ID. Through this process, the cache table is filled and reconfirmed, a password requesting and responding RADIUS attribute to the user ID is additionally defined. Further, the AP and the authentication server predetermine an identical security key and encrypting algorithm to be used for encryption and decryption, and only the AP and the authentication server know the security key. The user password should be encrypted when it is transmitted from the authentication server, and the AP received the encrypted password should decrypt the password. In the event that the user ID is registered in the cache time at the first time, the AP asks the authentication server for the transmission of the password for the user ID when an RESPONSE_AUTH message is received. At this instant, password requesting attribute is added and also transmitted to the authentication server. The authentication server encrypts the user password and adds ACCEPT_PACKET or REJECT_PACKET attribute, and then, transmits to the AP. The AP decrypts the encrypted user password, and registers in the authentication table.

The present invention can be implemented on a recording medium that can be read from by a computer with a code that is readable by the computer. The recording medium that can be read from by a computer may include any kind of recording devices in which data that is readable by the computer is stored. Examples of the recording medium include ROM, RAM, CD-ROM, magnetic tape, hard discs, floppy discs, flash memory, optical data storage devices, and even carrier wave, for example, transmission over the Internet. Moreover, the recording medium may be distributed among computer systems that are interconnected through a network, and the present invention may be stored and implemented as a code in the distributed system.

According to the above-described authentication method and system of the present invention, it is possible to improve an authentication process in a high speed wireless Internet service based on public WLAN technologies that are currently in operations. That is, since the authentication that has been required for the authentication server whenever a user asks for an access can be performed by the AP that is the first access point from the time when the service user accesses again, the access time, and therefore, the data traffic related to the authentication that has occurred in the backbone network can be considerably reduced to improve the speed of data transmission to the user of the high speed wireless Internet service. Further, in case of a small-scale network, it is possible to operate in such a way that an administrator inputs user ID and password in the authentication table not necessarily preparing a separate authentication server, and therefore, cost for operating an authentication server can be saved.

While the present invention has been particularly shown and described with reference to preferred embodiments thereof, it will be understood by those of ordinary skill in the art that various changes in form and details may be made therein without departing from the spirit and scope of the present invention as defined by the appended claims.

What is claimed is:

1. An authentication method for a public wireless local area network (WLAN) service system, which includes a WLAN user terminal and an access point (AP) for relaying WLAN communications to and from the user terminal, comprises the steps of:
the user terminal asking the AP for access to a physical port; and
the AP performing an authentication process with reference to authentication information stored in the AP.

2. An authentication method for a public wireless local area network (WLAN) service system, which includes a WLAN user terminal, an access point (AP) for relaying communications to and from the user terminal, and an authentication server for performing an authentication process in response to a request for authentication from the AP, comprises the steps of:
(a) the user terminal asking the AP for access to the public WLAN;
(b) the AP searching for authentication information stored in the AP;
(c) if the authentication information is found in step (b), the AP performing an authentication process; and
(d) if the authentication information is not found in step (b), the AP asking the authentication server for authentication, and the authentication server performing an authentication process.

3. The authentication method according to claim 2, wherein the search for authentication information stored in the AP in step (b) includes searching a cache table that stores at least a user identification (ID) code and a password.

4. The authentication method according to claim 3, wherein step (a) includes the user terminal asking the AP for access to a physical port; the AP asking the user terminal for a user ID code and, as a response, the user terminal transmitting its own user ID code to the AP, and if the AP is in an initialized mode or there is no authentication information in the cache table, step (a) additionally includes registering authentication information in the cache table of the AP, and wherein if the user ID code transmitted from the user terminal to the AP is not in the cache table, the registering includes the AP temporarily storing the user ID code in the cache table; the AP asking the authentication server for a user password corresponding to the user ID code; if the user password is in the authentication server, the authentication server informing the user terminal via the AP that the authentication is successful and transmitting the user password to the AP, and the AP storing the user password in a password storing shell of the user ID code temporarily stored in the cache table; and if the user password is not in the authentication server, the authentication server informing the user terminal via the AP that the authentication has failed, and registering a new password in the password storing shell of the user ID code temporarily stored in the cache table.

5. The authentication method according to claim 3, wherein step (a) includes the user terminal asking the AP for access to a physical port; and the AP asking the user terminal for a user ID code and, as a response, the user terminal transmitting its own user ID code to the AP, and if the user ID code transmitted from the user terminal is in the cache table of the AP, step (c) includes the AP asking the user terminal for a user password, and allowing or refusing an access to the public WLAN according to the results of checking whether the user password transmitted from the user terminal is identical to the password stored in the cache table or not.

6. The authentication method according to claim 5, further comprising the step of verifying if the authentication by the AP is correct, after allowing the access to the public WLAN, by comparing the user ID code and the user password for which the access is allowed upon the asking from the AP with a user ID code and a user password stored in the authentication server.

7. The authentication method according claim 5, further comprising the step of the authentication server periodically checking if authentication information in the authentication server and the AP is identical with each other by periodically comparing the user ID code and the user password in the cache table with the user ID code and the user password stored in the authentication server.

8. The authentication method according to claim 5, wherein the allowing or refusing the access includes the AP transmitting a user ID code for authentication to the authentication server if the access is refused because the user password is different while the user ID code is identical, and if a password is asked for from the authentication server, the AP transmitting the user password received from the user terminal to the authentication server after adding a password requesting attribute of a type predetermined with the authentication server; the authentication server transmitting an authentication success or authentication failure message to the user terminal after adding an encrypted password responding attribute according to the result of authentication of the user password of the user terminal; the AP transmitting the authentication success message to the user terminal if the authentication success message is received by the AP from the authentication server, and updating corresponding information in the cache table; and disconnecting the access if the authentication failure message is received by the AP from the authentication server, and updating the cache table with a new password received from the authentication server.

9. A computer readable recording medium that stores a program for the computer to implement the method claimed in any one of claims 1 to 8.

10. An authentication system for a public wireless local area network (WLAN) service system, comprising:
a user terminal for accessing to the public LAN;
an access point (AP) including a cache table for storing a user ID code and a user password, which checks the user ID code and the user password with reference to the cache table upon request from the user terminal for an access to the WLAN, and allows the access to the WLAN if the user ID code and the user password are confirmed, or transmits the user ID code and the user password to an authentication server if the user ID code and the user password are not confirmed; and
an authentication server that receives the user ID code and the user password from the AP and performs an authentication process whether to allow the access to the WLAN.
